(19) United States
(12) Patent Application Publication
(10) Pub. No.: US 2002/0138574 A1
(43) Pub. Date: Sep. 26, 2002

(54) Method and system for certifying compliance with a requirement

(75) Inventors: Anna Maria Brown, Dearborn, MI (US); Douglas E. Stoyer, Colorado Springs, CO (US); Judy Lynne VanDusen, Beverly Hills, MI (US)

Correspondence Address: BROOKS & KUSHMAN P.C./FGTI, 1000 TOWN CENTER, 22ND FLOOR, SOUTHFIELD, MI, 48098, US

(73) Assignee: Ford Motor Company, Dearborn, MI (US)

(21) Appl. No.: 10/063,118

(22) Filed: Mar. 22, 2002

Related U.S. Application Data
(60) Provisional application No. 60/277,870, filed on Mar. 22, 2001.

(51) Int. Cl. G06F 15/16; G06F 17/60; H04K 1/00

(52) U.S. Cl. 709/204; 705/51

(57) ABSTRACT

An online method and system are provided for certifying compliance with a requirement (i.e., standard, process, procedure, etc.). A user group that must comply with a requirement is defined. Members of the user group are automatically presented with an electronic communication informing them that they must certify their compliance with the requirement. The requirement is presented to the user group in an electronic format. Upon complying with the requirement, members of the user group submit an electronic communication certifying that they have complied with the requirement.

### CROSS REFERENCE TO RELATED APPLICATIONS

This application claims the benefit of U.S. provisional application Serial No. 60/277,870, filed Mar. 22, 2001.

### BACKGROUND OF INVENTION

1. Field of the Invention

The present invention relates generally to an online method and system for certifying compliance with one or more requirements (i.e., standards, processes, procedures, court orders, etc.) across an organization.

2. Background Art

Frequently, there is a need to establish cross-organizational compliance to standards, processes and procedures. This is especially true for larger, distributed and/or globally-disbursed organizations. Traditionally, compliance to such standards, processes and procedures included a manual process requiring on-site supervision, administration and maintenance. Compliance with these standards, processes and procedures is typically ascertained by an administrator, recorded on paper, signed off by a department manager, and forwarded by inter-company mail to the hosting organization. The conventional process is costly, time consuming and subject to inconsistencies throughout.

### SUMMARY OF INVENTION

The present invention comprises an online system and methodology to certify user compliance to organizational standards, processes and procedures. One advantage of the present invention is its ability to efficiently and effectively accommodate a large, distributed and/or global organization's needs. More specifically, the present invention allows a host organization central monitoring capabilities throughout the entire compliance process while effectively reaching range numbers of globally disbursed people. This advantage may include immediate access to up-to-date reports and statistics using multiple criteria. Another advantage of the present invention is its ability to facilitate communication in multiple languages.

To meet these features, advantages and objects of the present invention, as well as additional features, objects and advantages, a method embodiment of the present invention is provided that includes an online method for certifying compliance with a requirement (i.e., standard, process, procedure, etc.). In one embodiment of the invention, the method includes defining a user group that must certify compliance with a particular requirement. The user group may consist of only a single member.

The method additionally includes automatically presenting an electronic communication to each member of the user group to inform the members that they must certify their compliance with the requirement. The method additionally includes presenting the requirement to the user group in an electronic format and receiving an electronic communication from members of the user group to certify that they have complied with or will comply with the requirement.

A method embodiment may additionally include compiling a database containing a listing of user group members required to certify compliance with the requirement. A certification indicia attribute within the database may automatically indicate whether each listed member has certified that he or she is in compliance with the requirement.

A method embodiment may additionally include querying the database, at any time, for members of the user group that have certified and/or have not certified their compliance with the requirement. A report of certified and/or non-certified users may be generated based on the query. The report may be automatically generated at a pre-defined cutoff date by which members of the user group must certify their compliance with the requirement. The report may be generated or sent in an electronic format to managers of user group members.

A method embodiment may additionally include sending an electronic communication including a certification confirmation to members of the user group upon receiving their individual certificates of compliance.

A system embodiment of the present invention includes an online system for certifying compliance with a requirement (i.e., standard, process, procedure, etc.). In one embodiment, the system includes one or more server computers in operable communication with one or more databases and one or more client computers via a computer network. The server computer is configured to receive input defining a user group that must certify compliance with a requirement. The server computer is additionally configured to automatically present an electronic communication to each member of the user group to inform each member that he or she must certify compliance with the requirement. The server computer is additionally configured to present the requirement to the user group in an electronic format and receive an electronic communication from members of the user group certifying that those members have certified their compliance with the requirement.

The databases may contain a listing of each user group member required to certify compliance with the requirement and a certification indicia attribute indicating whether each member has certified that he or she is in compliance with the requirement. The server computer may be additionally configured to automatically update the certification indicia for a user group member upon receiving the certification from the at least one member.

The server computer may be additionally configured to query the one or more databases, at any time, for members of the user group that have certified and/or have not certified compliance with the requirement. The server computer may be additionally configured to generate a report of certified and/or non-certified users based on the query. The server computer may be additionally configured to automatically generate the report at a predefined cutoff date by which one or more members of the user group must certify their compliance with the requirement. The server computer may be additionally configured to send the report in an electronic format to managers of the user group members.

The server computer may be additionally configured to automatically send an electronic communication including a certification confirmation to members of the user group upon receiving their respective certifications.

The above objects and other objects, features and advantages of the present invention are readily apparent from the following detailed description of the preferred embodiments for carrying out the invention, when taken in connection with the accompanying drawings.

### BRIEF DESCRIPTION OF DRAWINGS

FIG. 1 is a block flow diagram illustrating a preferred methodology for implementing the present invention;

FIG. 2 is a block flow diagram illustrating a certification reporting/follow-up methodology in accordance with the present invention;

FIG. 3 is a web browser interface illustrating an example Compliance Certification Homepage in accordance with one embodiment of the present invention;

FIG. 4 is a web browser interface illustrating an example Certificate of Compliance submission form in accordance with one embodiment of the present invention;

FIG. 5 is a web browser interface illustrating an example search/report query page for certified users in accordance with one embodiment of the present invention;

FIG. 6 is a web browser interface illustrating an example search/report query page for non-certified users in accordance with one embodiment of the present invention;

FIG. 7 is a web browser interface illustrating an example certification database search results/report page in accordance with one embodiment of the present invention; and

FIG. 8 is a schematic representation of an example system embodiment of the present invention.

### DETAILED DESCRIPTION

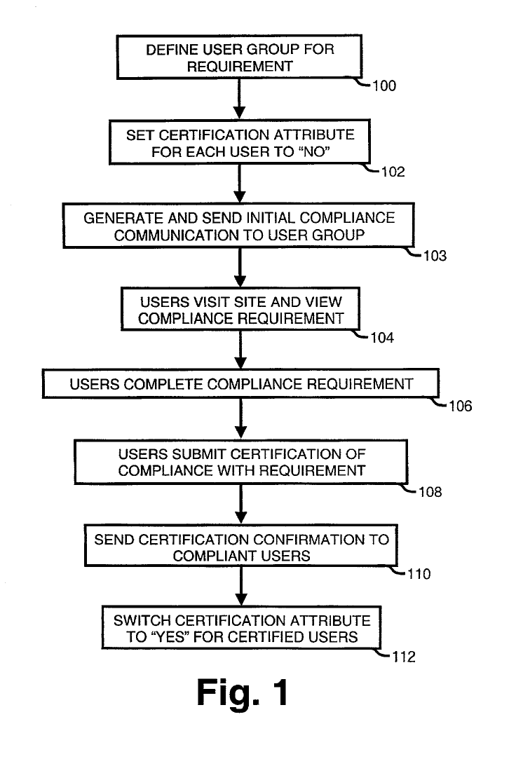

FIG. 1 is a block flow diagram illustrating a preferred methodology for implementing the present invention. Notably, the content and arrangement of the preferred methodology illustrated in FIG. 1 may be adapted or modified within the scope of the present invention to best fit a particular implementation.

As represented in block 100, a user group that must comply with a requirement is defined. Notably, the user “group” may be as small as a single user. n one embodiment of the present invention, the user group is defined within a database of requirements/user groups (a “certification database”). User attributes within the certification database may include organizational code, employee type, location, level, and/or manager. Content for the certification database may be compiled based on existing corporate databases or a data warehouse tracking employees, suppliers, vendors, management, etc. For example, a certification database may be extracted from a corporate human resources database.

The certification database may contain a plurality of user groups corresponding to one or more standards, processes or procedures (i.e., “requirements”) with which members of the user groups must comply. A single user may have to comply with multiple requirements. For each requirement within the compliance database, each member of the corresponding user group possesses a certification status attribute adjustable to “Yes” or “No”. In the preferred embodiment, each user's certification status attribute is initially defaulted to “No,” as represented in block 102.

As represented in block 103, users listed within the certification database receive a communication indicating that they are not certified for compliance with one or more requirements. In one embodiment, the communication comprises an e-mail sent automatically to each non-certified user at a regular interval or administrator-defined time. Preferably, the communication includes a request asking the recipient to visit a Compliance Certification Website. In one embodiment, a hyperlink to a Compliance Certification Website is provided in the communication to the user. Preferably, the Compliance Certification Website is Internet or intranet accessible by users with a conventional hyper-text markup language browser.

As represented in block 104, users visit the Compliance Certification Website to view their individual compliance requirement(s) for which they must certify themselves. In one embodiment, the Compliance Certification Website is automatically and individually customized for each user. User identification may be achieved via user login or user-identifying indicia (i.e., cookie, token, etc.).

As represented in block 106, users complete their individual compliance requirements set forth at the Compliance Certification Website. Upon reviewing or completing a compliance requirement, a user visits the Compliance Certification Website to complete/submit a Certificate of Compliance for the completed requirement, as represented in block 108.

As represented in block 110, a certification confirmation communication is automatically sent to each user who submits a Certificate of Compliance. The confirmation provides the user with a written confirmation of his or her compliance and certification transaction. Upon submitting the Certificate of Compliance, the user's status attribute corresponding to the requirement within the certification database is updated to “Yes”, as represented in block 112.

In one embodiment of the present invention, the step represented in block 103 is repeated at administrator-defined or periodic time intervals for users that have received an initial compliance communication, but who have not yet submitted their certificate of compliance for each of the requirements with which they are individually responsible for complying.

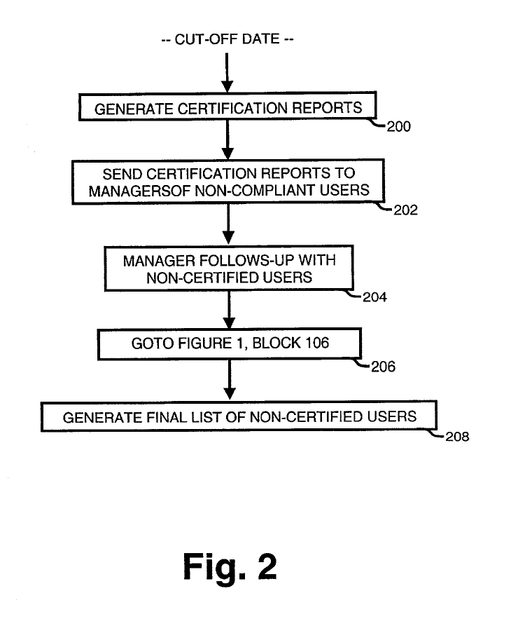

FIG. 2 is a block flow diagram illustrating a certification reporting/follow-up methodology in accordance with the present invention. In one embodiment of the present invention, a cutoff date for certification of compliance with a particular requirement, user or user group is set. The cutoff date is the date by which users required to comply with a particular requirement must submit their respective certificates of compliance.

As represented in block 200, certification reports may be generated after the cutoff date has passed. Reports can be administrator-defined to include a listing sorted to a variety of attributes including but not limited to user name, department, compliance requirement, compliance status, user status, building, manager, etc.

In one embodiment of the present invention, reports identifying non-certified users are sent to managers of non-certified users, as represented in block 202. Preferably, these managers follow-up with their respective non-certified users as represented in block 204. In this embodiment, the managers encourage or require that the non-certified users follow through with their respective compliance requirements and submit the corresponding certificate(s) of compliance, as represented in block 206.

Additionally, user managers may receive a communication requesting updated information for the certification database. This may occur, for example, where a user identification in the certification database has been changed or is invalid.

Following manager follow-up, a final list of non-certified users can be generated from the certification database, as represented in block 208. Based on this list, a variety of administrative actions may be followed. For example, where a certified user is identified as non-certified in the final list, that user's manager can update the certification database to confirm that user's proper status or delete that user's name from the certification or other database.

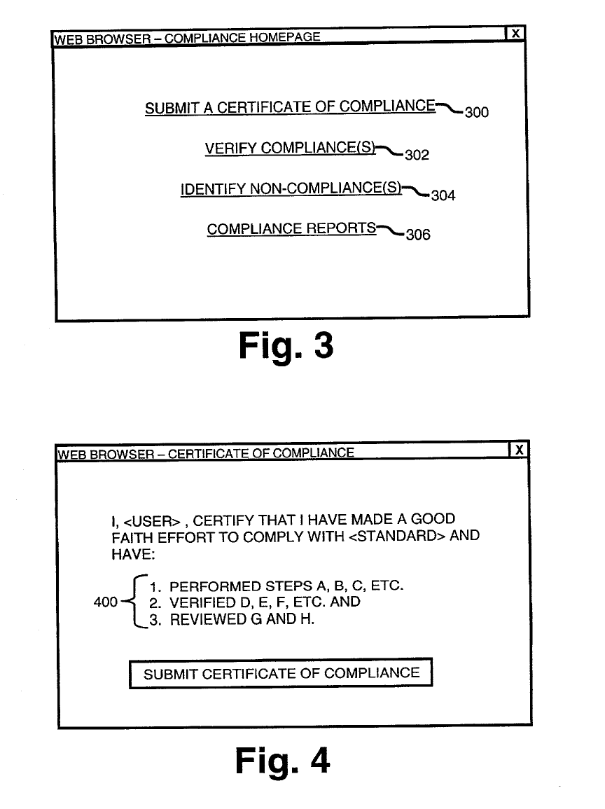

FIG. 3 is a web browser interface illustrating an example Compliance Certification Homepage in accordance with one embodiment of the present invention. Notably, the content of the browser interface shown in FIG. 3, as well as all example browser interfaces illustrated in accordance with the present invention, can be supplemented or modified within the scope of the present invention to best fit a particular implementation scenario.

Depending on client status (i.e., user, manager, administrator, etc.), the hyperlinks and content presented at the Compliance Certification Website may vary. For example, users may not be able to verify compliance of other users, identify non-compliance(s), generate certification/non-certification reports, etc.

As illustrated in the example browser interface shown in FIG. 3, a hyperlink 300 is provided enabling a user to submit a certificate of compliance. A hyperlink 302 is provided enabling a manager to verify the certification status of a user or user group. A hyperlink 304 is provided enabling a manager to identify non-certified users or user groups. A hyperlink 306 is provided enabling a manager to generate certification/non-certification reports. Additional information that may be presented at the Compliance Certification Website includes but is not limited to links to relevant sites and resources, background information, training information, tutorials, frequently asked questions, a “Help” hyperlink and/or a feedback form.

FIG. 4 is a web browser interface illustrating an example Certificate of Compliance submission form in accordance with one embodiment of the present invention. Preferably, the Certificate of Compliance is automatically customized for the user to identify the user's name, the particular requirement for which certification is sought, and the primary steps 400 to fulfill that requirement. User identification may be achieved via user login or user-identifying indicia (i.e., cookie, token, etc.).

Provided the browsing user has fully satisfied the compliance requirement, the user selects button 402 to submit his or her Certificate of Compliance.

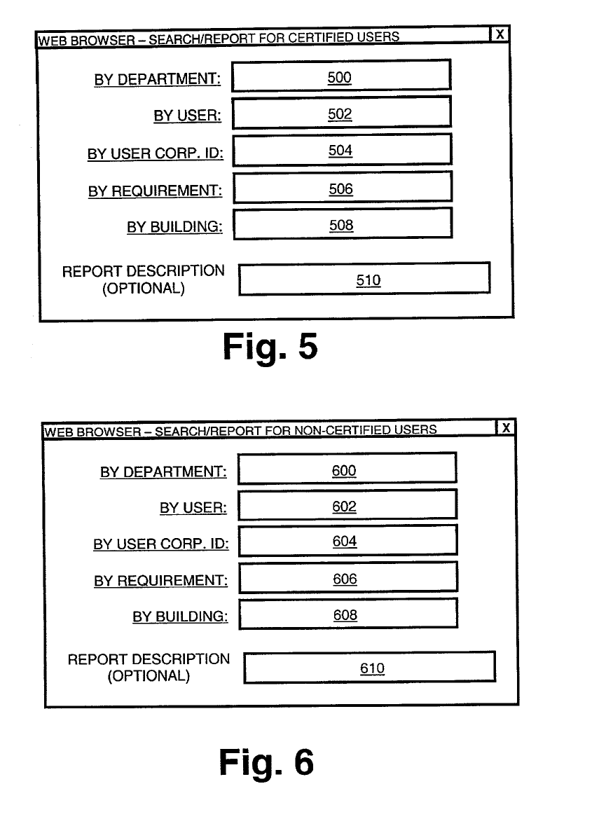

FIG. 5 is a web browser interface illustrating an example search/report query page for certified users in accordance with one embodiment of the present invention. In one embodiment, the certification database can be queried by a variety of attributes including but not limited to department 500, user, 502, user corporate identification code 504, requirement 506, building 508, etc. Preferably, a hyperlink corresponding to each attribute is provided enabling a manager to view each item in each attribute category (e.g., “BY BUILDING”: a listing each building within the host organization). Optionally, a report description field 501 is provided enabling a manager to define a customized title for the search/report.

FIG. 6 is a web browser interface illustrating an example search/report query page for non-certified users in accordance with one embodiment of the present invention. In one embodiment, the certification database can be queried by a variety of attributes including but not limited to department 600, user, 602, user corporate identification code 604, requirement 606, building 608, etc.

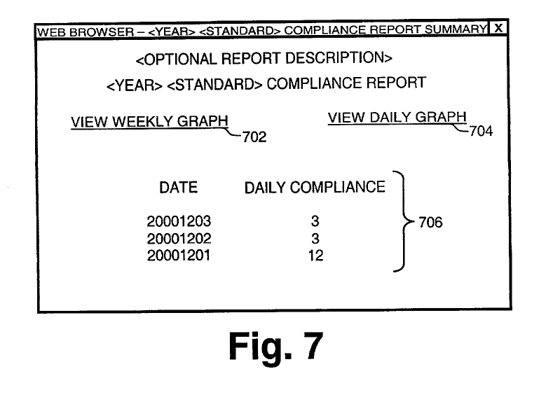

FIG. 7 is a web browser interface illustrating an example certification database search results/report page in accordance with one embodiment of the present invention. The content of the search results/report page may include but is not limited to the optional report description, a title for the report, a hyperlink 700 to view a weekly compliance graph, a hyperlink 702 to view a daily certification graph, and a summary 704 of the daily certification status by date.

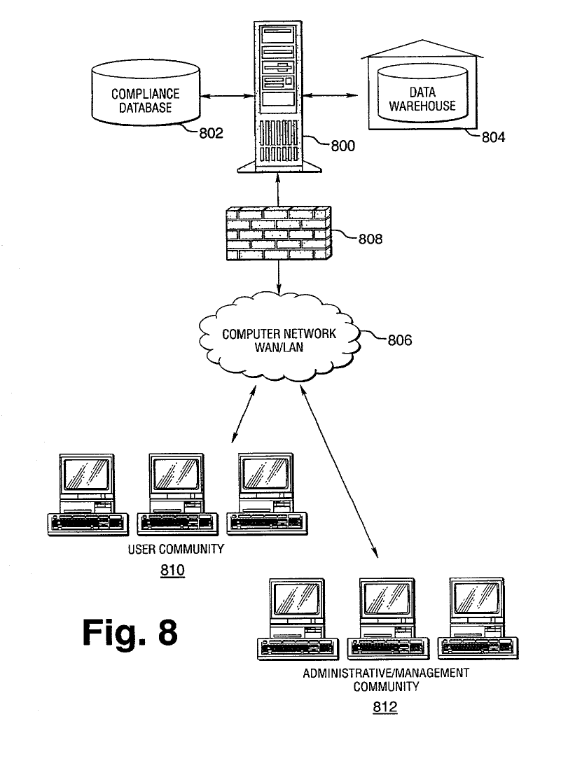

FIG. 8 is a schematic representation of an example system embodiment of the present invention. Notably, the architecture of the system illustrated in FIG. 8 may be adapted or modified within the scope of the present invention to best fit a particular implementation. Host organization server(s) 800 is/are operably interconnected with certification/compliance database(s) 802. In one embodiment, host organization server(s) 800 is/are interconnected with a host organization data warehouse 804. Host organization data warehouse may contain data including but not limited to human resources data, requirement data, etc.

Host server(s) 800 is/are configured for operable communication via computer network 806 and firewall 808 with a plurality of client computers including but not limited to a user community 810 and an administrative/management community 812. In one embodiment, the computer network is independently or in combination a local area network (LAN), an intranet, or a wide area network (WAN) including the Internet.

While the best mode for carrying out the invention has been described in detail, those familiar with the art to which this invention relates will recognize various alternative designs and embodiments for practicing the invention as defined by the following claims.

1. An online method for certifying compliance with a requirement comprising:
defining a user group that must certify compliance with a requirement;
automatically presenting an electronic communication to each member of the user group wherein the communication informs each member that he or she must certify compliance with the requirement;
presenting the requirement to the user group in an electronic format; and
receiving an electronic communication from at least one member of the user group wherein the communication includes a certification that the at least one member has complied or will comply with the requirement.

2. The method of claim 1 further comprising compiling a database containing a listing of one or more user group members required to certify compliance with the requirement wherein a certification indicia indicates whether each listed member has certified that he or she is in compliance with the requirement.

3. The method of claim 2 wherein the certification indicia automatically indicates that the at least one member has certified compliance with the requirement upon receiving the certification from the at least one member.

4. The method of claim 2 additionally comprising querying the database for members of the user group that have certified and/or have not certified their compliance with the requirement.

5. The method of claim 4 additionally comprising generating a report of certified and/or non-certified users based on the query.

6. The method of claim 5 wherein the report is automatically generated at a predefined cutoff date by which one or more members of the user group must certify their compliance with the requirement.

7. The method of claim 5 further comprising sending the report in an electronic format to one or more managers of one or more members of the user group.

8. The method of claim 1 further comprising automatically sending an electronic communication including a certification confirmation to the at least one member upon receiving the certification from the at least one member.

9. An online system for certifying compliance with a requirement comprising one or more server computers in operable communication with one or more databases and one or more client computers via a computer network wherein the computer server is configured to:
receive input defining a user group that must certify compliance with a requirement;
automatically present an electronic communication to each member of the user group wherein the communication informs each member that he or she must certify compliance with the requirement;
present the requirement to the user group in an electronic format; and
receive an electronic communication from at least one member of the user group wherein the communication includes a certification that the at least one member has complied or will comply with the requirement.

10. The system of claim 9 wherein the one or more databases contain a listing of each user group member required to certify compliance with the requirement, and wherein a certification indicia indicates whether each member has certified that he or she is in compliance with the requirement.

11. The system of claim 10 wherein the server computer is additionally configured to automatically update the at least one user group member's certification indicia to indicate that the at least one member has certified compliance with the requirement upon receiving the certification from the at least one member.

12. The system of claim 10 wherein the server computer is additionally configured to query the one or more databases for members of the user group that have certified and/or have not certified compliance with the requirement.

13. The system of claim 12 wherein the server computer is additionally configured to generate a report of certified and/or non-certified users based on the query.

14. The system of claim 13 wherein the server computer is additionally configured to automatically generate the report at a predefined cutoff date by which one or more members of the user group must certify their compliance with the requirement.

15. The system of claim 13 wherein the server computer is additionally configured to send the report in an electronic format to one or more managers of one or more members of the user group.

16. The system of claim 9 wherein the server computer is additionally configured to automatically send an electronic communication including a certification confirmation to the at least one member upon receiving the certification from the at least one member.
